(19) United States
(12) Patent Application Publication
(10) Pub. No.: US 2026/0177699 A1
(43) Pub. Date: Jun. 25, 2026

(54) FUSION OF RAW MEASUREMENT DATA, OBTAINED USING AN ACTIVE MEASURING PRINCIPLE, AND IMAGES TO FORM A REPRESENTATION WITH DEPTH AND/OR DISTANCE INFORMATION

(71) Applicant: Robert Bosch GmbH, Stuttgart (DE)

(72) Inventors: Oliver Lange, Hemmingen (DE); Michael David Warren, Tuebingen (DE)

(21) Appl. No.: 18/833,497

(22) PCT Filed: Feb. 16, 2023
(86) PCT No.: PCT/EP2023/053833

§ 371 Date: Jul. 26, 2024

(30) Foreign Application Priority Data
Mar. 3, 2022 (DE) 10 2022 202 174.6

(51) Int. Cl. G01S 17/86; G01B 11/22; G01S 17/931; G06T 7/579; G06T 7/593

(52) U.S. Cl. CPC G01S 17/86; G01B 11/22; G01S 17/931; G06T 7/579; G06T 7/593; G06T 2207/10012; G06T 2207/10028; G06T 2207/20081; G06T 2207/20084

(57) ABSTRACT

A method for creating a representation of an area from measurement data obtained by observing the area. Measurement data of a first measuring modality are provided, wherein these measurement data contain an interesting property of the reflected wave, which depends on the distance between the location of reflection and the sensor used for the measurement, along a view beam. At least one image of the observed area that was acquired with a second measuring modality is provided. From the geometric arrangement of the sensors used for the two measuring modalities, in relation to one another, correspondences are ascertained as to which points of the at least one image on the one hand and points along view beams on the other hand relate to the same location in the area. For the same location in the area, multiple hypotheses relating to the position of the location in space are formulated.

### FIELD

The present invention relates to the evaluation of measurement data of multiple measuring modalities for generating as accurate and safe a representation of an observed area as possible, for example for the purposes of at least partially automated driving.

### BACKGROUND INFORMATION

A vehicle driving in an at least partially automated manner must respond to objects and events in its environment. For this purpose, the vehicle environment is monitored with various sensors, such as cameras, radar sensors or lidar sensors. The measurement data acquired with these different measuring modalities are often fused for finally determining which objects are present in the environment of the vehicle. PCT Patent Application No. WO 2018/188 877 A1 describes an exemplary method for fusing measurement data across multiple measuring modalities.

### SUMMARY

The present invention provides a method for creating a representation, containing depth and/or distance information, of an area. The method uses measurement data obtained by observing the area with at least two different measuring modalities. Measurement data of both measuring modalities are thus provided.

According to an example embodiment of the present invention, the first measuring modality transmits an electromagnetic or acoustic wave into the observed area and receives a reflected wave from this area. At least one interesting property, such as the amplitude or, in the case of frequency modulation, the frequency, of this reflected wave is measured. In addition, a direction from which the reflected wave impinges from the observed area on the sensor used for the measurement may also be assigned to the reflected wave. In geometric approximation, the reflected wave can thus be interpreted as a view beam that impinges from the location of reflection in a straight line on the sensor. The interesting property of the reflected wave can then be represented along the view beam, depending on the distance between the location of reflection and the sensor used for the measurement. Such spatial and/or temporal profiles of the interesting property are the raw data that are typically captured with active measurements of this type. The first measuring modality may, for example, in particular be a radar measurement, a lidar measurement or an ultrasonic measurement. Such measurements are in particular often used to recognize objects in the environment of a vehicle or robot.

According to an example embodiment of the present invention, the second measuring modality provides at least one image of the observed area. Suitable in this respect are, for example, in particular camera images, video images or thermal images. Such images may, for example, be acquired with structured lighting or time-of-flight techniques, which also directly measure depth information. Such an image may, for example, be encoded as an RGBD image, which contains not only the RGB color information but also the depth. Multiple cameras may, for example, in particular also be stereoscopically combined so that multiple images of the observed area are simultaneously produced from different perspectives. At least one moving camera may also be used, and depth information may be ascertained with a structure-from-motion technique. The images may, for example, be in the form of intensity values arranged in a two- or three-dimensional grid. However, images may, for example, also be in the form of point clouds in which the points that are occupied with intensity values do not form a contiguous region.

According to an example embodiment of the present invention, from the geometric arrangement of the sensors used for the two measuring modalities, in relation to one another, correspondences are ascertained as to which points of the at least one image on the one hand and points along view beams on the other hand relate to the same location in the area. Such a correspondence may, for example, indicate that a particular location X on a view beam between the sensor used for the first measuring modality and an object also located in the field of view of two stereoscopically arranged cameras is represented in the image of the first camera by a pixel x_{c1} and in the image of the second camera by another pixel x_{c2}.

According to an example embodiment of the present invention, for one and the same location in the area, multiple hypotheses relating to the position of this location in space are in each case formulated using the measurement data of the first measuring modality, the at least one image and/or the ascertained correspondences. In doing so, the full raw signal is used in contrast to conventional methods, which further take into account a highly compressed processing result of the measurement data (for example in the form of one or more peaks). As explained above, this raw signal comprises temporal and/or spatial profiles of an interesting property of the wave reflected from the observed area.

The hypotheses may, for example, selectively relate to the depth and/or distance information of the location but also to the coordinates of the position of the location as a whole, for example. The various hypotheses may, for example, in particular be based on depth and/or distance information originating from various sources. For example, a first hypothesis may be based on depth and/or distance information derived from the active measurement with the electromagnetic or acoustic wave. A second hypothesis, on the other hand, may, for example, be based on depth and/or distance information derived from a stereoscopic combination of two images.

According to an example embodiment of the present invention, the hypotheses are aggregated in the desired representation to form depth and/or distance information at the respective location. Such aggregating may, for example, in particular include that depth and/or distance information underlying one of the hypotheses is corrected such that a correspondingly updated hypothesis is then as consistent as possible with the one or the further hypotheses.

The depth and/or distance information in the representation may, for example, in particular, comprise at least one coordinate of the position of the location in space. However, the depth and/or distance information may, for example, also selectively relate to a distance between the location and a specified reference point, for example the position of the sensor used for the first measuring modality.

It has been found that aggregating can significantly improve the accuracy of the ultimately obtained depth and/or distance information in the representation. In particular, distances to objects in the observed area can be determined more accurately. For example, the shape of peaks in a radar signal or lidar signal may also be evaluated more accurately. Information about surface normals and roughness may, for example, be ascertained from this shape.

The depth and/or distance information also becomes more reliable in that it is always based on at least two independent measurements with at least two different measuring modalities. If one of these measurements provides completely nonsensical results, for example because a sensor is defective, dirty or misaligned, this will become apparent at the latest when aggregating.

In that the active measurement with the electromagnetic or acoustic wave on the one hand and the imaging with at least one camera on the other hand supplement one another, the probability that objects are entirely absent in the representation or, conversely, that the representation contains “ghost objects” that are not at all present in reality is furthermore reduced. By fusion with additional information from one or more camera images, objects hidden in the noise of a lidar signal can thus be raised above the noise level and thus be made recognizable. Likewise, a lidar signal can measure the shaping of extended but only weakly textured objects, which are difficult and inaccurate to ascertain from images of these objects, significantly more accurately. Conversely, the probability that both measuring modalities will recognize a “ghost object” at the same location due to measurement artifacts is very low due to the fundamental physical differences between the measuring modalities.

As a whole, the method according to the present invention can significantly increase the safety integrity of environment detection, in particular in safety-relevant systems. Any depth information fused from the raw signals of at least two independent measurements is more accurate, more reliable, and less likely false.

Fusions between radar measurement data or lidar measurement data on the one hand and images on the other hand already exist. In contrast to previous approaches, the full raw signal of the first measuring modality is however used within the scope of the method of the present invention described here. Thus, for each view beam considered, the entire curve of the interesting property is taken into account depending on the distance between the sensor and the location of reflection along this view beam. In earlier approaches, on the other hand, only peaks were extracted from the raw signal and processed further. In this case, the raw signal was highly compressed. This is approximately comparable to extracting bounding boxes around visible objects as features from an image, for example.

According to an example embodiment of the present invention, at least one hypothesis can be formulated using measurement data of the first measuring modality on the one hand and information from the at least one image on the other hand, which relate to the same location as evidenced by the correspondences. For example, for a location on the view beam between the sensor used for the first measuring modality and an object, the correspondences can be used to ascertain which pixels in one or more camera images include information about exactly this location. Due to the known geometric arrangement of the sensors used for the two measuring modalities, in relation to one another, correspondences of this type already contain a hypothesis as to where exactly said location is in three-dimensional space. The interesting property provided by the first measuring modality, such as amplitude and/or frequency, on the one hand and the image information with respect to this location on the other hand may then be used to test the hypothesis, for example.

Alternatively or in combination, according to an example embodiment of the present invention, at least one hypothesis may be formulated using images acquired by two or more cameras of a stereoscopic camera arrangement and/or by at least one moving camera with a structure-from-motion technique. The known geometric arrangement of the cameras reveals where a location, which in each case causes a particular intensity signal at two different points in the respective camera images, should be in space.

If additional depth information is available for a camera image, a hypothesis as to where a location addressed by a particular image pixel should be physically located may also be formulated from the depth information. Such additional depth information may, for example, in particular be ascertained with a correspondingly trained artificial neural network (KNN).

In a particularly advantageous embodiment of the present invention, a profile of intensity values and/or correlation values along the view beam is ascertained from the stereoscopically acquired images, or from the image and the additional depth information, in conjunction with the geometry of the view beam and the correspondences. Correlation values may, for example, be ascertained from two stereoscopically acquired images as a correlation between image regions (“patches”) that respectively correspond in the two images to one and the same point on the view beam. Distance information in the measurement data of the first measuring modality is then corrected such that the profile of these measurement data along the view beam is as consistent as possible with the ascertained profile of the intensity values and/or correlation values. The fusion of the measurement data of both measuring modalities is then centered on the first measuring modality in the sense that
the alignment with the image data of the second measuring modality takes place in the space of the measurement curves typical for the first measuring modality, and
an improved measurement curve of this type is obtained as a result of this alignment.

In this way, “ghost objects” that may occur in the measurement data of the first measuring modality as an accompanying effect for recognizing a true object may, for example, in particular be suppressed since the occurrence of “ghost objects” is bound to the specific first measuring modality.

For example, points along the view beam may be sampled on the basis of a geometric description of the view beam. On the basis of the geometric arrangement of the sensors used for the two measuring modalities, in relation to one another, points corresponding to the sampled points can then be ascertained in the at least one image. Alternatively or in combination, multiple hypotheses relating to the positions of sampled points in space can in each case be formulated and aggregated. In particular, the points to be sampled may be selected from the discrete measurement points for which measurement data were actually acquired in the measurement with the first measuring modality.

In a further, particularly advantageous embodiment of the present invention, a distribution of intensity values in a correlation volume is ascertained from the stereoscopically acquired images, or from the image and the additional depth information. The measurement data along the view beam are projected into the correlation volume. The depth information obtained from the stereoscopically acquired images, or the additional depth information, is then corrected such that the distribution of the intensity values in the correlation volume is as consistent as possible with the measurement data of the first measuring modality. An improved depth estimate thus results for the locations indicated by the stereoscopically acquired image, or by the individual image and additional depth information. The fusion of the measurement data of both measuring modalities is then centered on the second measuring modality in the sense that
the alignment with the measurement data of the first measuring modality takes place in a correlation volume spanned by images of the second measuring modality, and
improved depth information relating to images of the second measuring modality, i.e., for example, a depth map, is obtained as a result of this alignment.

For example, points may be sampled from the at least one image. On the basis of the geometric arrangement of the sensors used for the two measuring modalities, in relation to one another, points corresponding to the sampled points can then be ascertained along the view beam. Alternatively or in combination, multiple hypotheses relating to the positions of sampled points in space can in each case be formulated and aggregated.

If a corresponding point to a point on the view beam is ascertained in the at least one image or, conversely, if a corresponding point to a point in the image is ascertained on the view beam, it is not ensured that the image, or the view beam, actually contains measured values or intensity values at the location indicated by the correspondences in each case. In particular, measurements with the first measuring modality on the one hand and images on the other hand are sampled with different resolutions. The pixel resolution of images is typically considerably finer than the range resolution of, for example, lidar measurements.

According to an example embodiment of the present invention, one option of supplementing missing measured values or intensity values is to fit a parameterized approach for the measured values or intensity values to the points in the at least one image or to the measurement points of the first measuring modality. This parametrized approach is explained everywhere. The corresponding points and associated measured values or intensity values can then be retrieved from this approach.

According to an example embodiment of the present invention, a second option for supplementing missing measured values or intensity values is to interpolate the corresponding points as well as the associated measured values and/or intensity values between points in the at least one image, or between measurement points of the first measuring modality. The interpolation thus also makes it possible to obtain corresponding points in the image, or along the view beam, on a finer scale than is provided by the sampling of the image, or of the view beam.

In a particularly advantageous embodiment of the present invention, an environment of a vehicle or robot is selected as the observed area. Especially with vehicles and robots, the multimodal observation of the environment, for example with radar or lidar on the one hand and with one or more cameras on the other hand, creates an increased level of safety because objects with which the vehicle, or the robot, could collide are less likely to be overlooked.

A control signal is therefore ascertained from the representation in a further advantageous embodiment. The vehicle, or the robot, is controlled with this control signal. The probability that the control signal triggers an appropriate response of the vehicle, or of the robot, to a traffic situation detected in the environment is then advantageously increased.

The method according to the present invention may in particular be fully or partly computer-implemented. The present invention therefore also relates to a computer program comprising machine-readable instructions, which, when they are executed on one or more computers, cause the computer(s) to perform the described method. In this sense, control devices for vehicles and embedded systems for technical devices that are likewise capable of executing machine-readable instructions are also to be regarded as computers.

Likewise, the present invention also relates to a machine-readable data carrier and/or to a download product with the computer program. A download product is a digital product that can be transmitted via a data network, i.e., can be downloaded by a user of the data network, and may, for example, be offered for sale in an online shop for immediate download.

A computer can furthermore be equipped with the computer program, with the machine-readable data carrier or with the download product according to the present invention.

In the simplest case, the method of the present invention manages with only one sensor for the first measuring modality and a monocular camera. However, the more cameras are used, the better the results will be.

Ideally, according to an example embodiment of the present invention, the times at which the sensor of the first measuring modality on the one hand and the cameras on the other hand acquire data are coordinated with one another such that the measurement data of the first measuring modality on the one hand and the images on the other hand relate to precisely the same times and time periods. That is to say, both the beginning and the duration of the data acquisition should be coordinated. In this way, systematic errors in the observation of dynamic situations are minimized. For example, a lightning lidar may be used in combination with a global shutter camera that is synchronized therewith and images the entire scene at once. For example, a scanning lidar may also be combined with a camera with a rolling shutter.

Ideally, according to an example embodiment of the present invention, the geometric properties of the sensor of the first measuring modality on the one hand and the cameras on the other hand are coordinated with one another. The observation areas, orientations and spatial resolutions of the respective sensors may thus, for example, in particular be coordinated with one another so that it is possible on the one hand to cover the required distance range and on the other hand not to acquire excess data for which there is no matching “counterpart” of the other measuring modality for fusing.

If the coordinate origins of the lidar sensor on the one hand and of the cameras on the other hand are additionally arranged along a line, analogously to a perfect stereo configuration, the projections of lidar view beams extend along image rows. The corresponding memory accesses to image contents can then proceed faster.

The lidar scans can advantageously also correspond to columns and/or rows of the images by controlling the rotating mirrors of the lidar sensor accordingly.

Further measures improving the present invention are described in more detail below with reference to the figures, together with the description of the preferred exemplary embodiments of the present invention.

### BRIEF DESCRIPTION OF THE DRAWINGS

FIG. 1 shows an exemplary embodiment of the method 100 for creating a representation 2, containing depth information, of an area 1, according to the present invention.

FIG. 2 shows a schematic diagram of the merging of lidar measurement data 3 with camera images 4, 4′, according to an example embodiment of the present invention.

FIG. 3 shows exemplary correction of distances in lidar measurement data 3 on the basis of camera images 4, 4′, according to the present invention.

FIG. 4 shows exemplary correction of depth information from camera images 4, 4′ on the basis of lidar measurement data 3, according to an example embodiment of the present invention.

### DETAILED DESCRIPTION OF EXAMPLE EMBODIMENTS

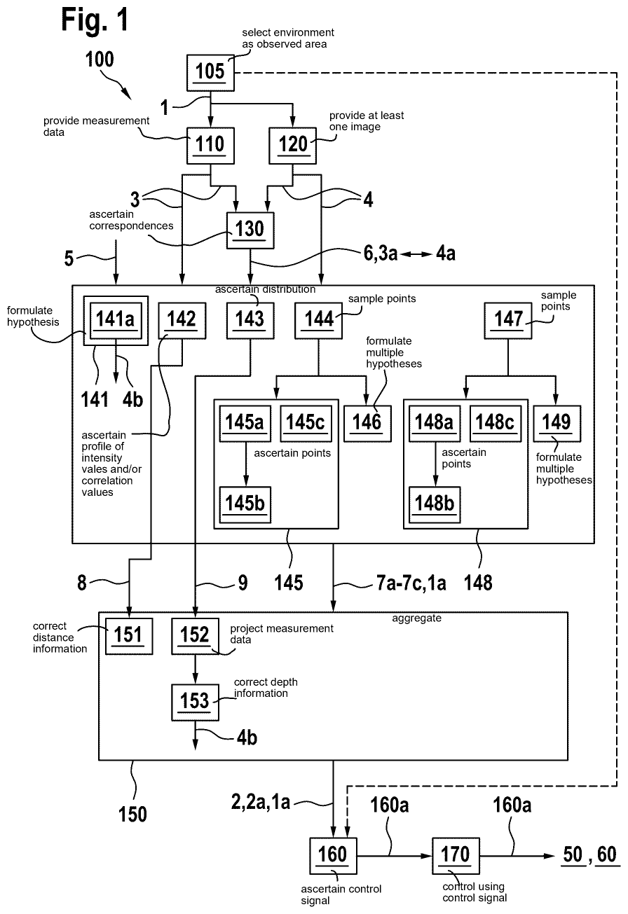

FIG. 1 is a schematic flow diagram of an exemplary embodiment of the method 100 for creating a representation 2, containing depth and/or distance information, of an area 1.

In step 110, measurement data 3 of a first measuring modality, which transmits an electromagnetic or acoustic wave into the observed area 1 and receives a reflected wave from this area (1), are provided. These measurement data 3 contain an interesting property of the reflected wave, such as an amplitude and/or a frequency, which depends on the distance between the location of reflection and the sensor used for the measurement, along a view beam S. This measured variable may thus, for example, directly be the distance. However, the distance may, for example, also be encoded in the time of flight.

In step 120, at least one image 4 of the observed area 1 that was acquired with a second measuring modality is provided.

In step 130, from the geometric arrangement 5 of the sensors used for the two measuring modalities, in relation to one another, correspondences 6 are ascertained as to which points 4a of the at least one image 4 on the one hand and points 3a along the view beams S on the other hand relate to the same location 1a in the area 1.

In step 140, multiple hypotheses 7a-7c relating to the position of said location la in space are now formulated. Each of these hypotheses 7a-7c by itself may be based on the measurement data 3 of the first measuring modality, the at least one image 4, the ascertained correspondences 6, and any combinations thereof. The entirety of all hypotheses 7a-7c formulated preferably makes use of all these data sources, i.e., measurement data 3, image 4 and correspondences 6.

In step 150, the hypotheses 7a-7c are aggregated in the desired representation 2 to form depth and/or distance information 2a with respect to the location 1a.

According to block 105, an environment of a vehicle 50 or robot 60 may be selected as an observed area 1. In step 160, a control signal 160a can then be ascertained from the representation 2. The vehicle 50, or the robot 60, can then be controlled with this control signal 160a in step 170.

According to block 141, at least one hypothesis 7a-7c can be formulated
using measurement data 3 of the first measuring modality on the one hand and information from the at least one image 4 on the other hand, which relate to the same location as evidenced by the correspondences 6, and/or
using images 4 acquired by two or more cameras of a stereoscopic camera arrangement and/or by at least one moving camera with a structure-from-motion technique, and/or
using an image 4 in combination with additional depth information 4b with respect to this image 4.

In this case, for example in particular according to block 141a, the additional depth information 4b with respect to the image 4 may be ascertained with a trained artificial neural network (KNN).

According to block 142, a profile of intensity values and/or correlation values 8 along the view beam S can be ascertained from the stereoscopically acquired images 4, or from the image and the additional depth information 4b, in conjunction with the geometry of the view beam S and the correspondences 6. This profile contains new hypotheses 7a-7c relating to the position of locations la about which the measurement data 3 of the first measuring modality also already make a statement. Accordingly, according to block 151, distance information in the measurement data 3 of the first measuring modality can then be corrected such that the profile of these measurement data 3 along the view beam S is as consistent as possible with the ascertained profile of the intensity values and/or correlation values 8.

According to block 143, a distribution 9 of intensity values in a correlation volume can be ascertained from the stereoscopically acquired images 4, or from the image 4 and the additional depth information 4b. This distribution 9 contains hypotheses 7a-7c relating to the position of locations 1a. These hypotheses 7a-7c can be merged with further hypotheses 7a-7c that the measurement data 3 provide with respect to the same locations 1a. For this purpose, according to block 152, the measurement data 3 along the view beam S can be projected into the correlation volume. According to block 153, the depth information 4b obtained from the stereoscopically acquired images 4, or the depth information 4b provided in addition to the image 4, can then be corrected such that the distribution 9 of the intensity values in the correlation volume is as consistent as possible with the measurement data 3 of the first measuring modality.

According to block 144, points 3a along the view beam S can be sampled on the basis of a geometric description of the view beam S. According to block 145, on the basis of the geometric arrangement 5 of the sensors used for the two measuring modalities, in relation to one another, points 4a corresponding to the sampled points 3a can then be ascertained in the at least one image 4. Alternatively or in combination, according to block 146, multiple hypotheses 7a-7c relating to the positions of sampled points 3a in space can in each case be formulated in order then to be aggregated in step 150.

According to block 147, points 4a can be sampled from the at least one image 4. According to block 148, on the basis of the geometric arrangement 5 of the sensors used for the two measuring modalities, in relation to one another, points 3a corresponding to the sampled points 4a can then be ascertained along the view beam S. Alternatively or in combination, according to block 149, multiple hypotheses 7a-7c relating to the positions of sampled points 4a in space can in each case be formulated in order then to be aggregated in step 150.

In this case, ascertaining corresponding points 4a, 3a according to block 145a, or 148a, can in each case comprise fitting a parameterized approach to the points in the at least one image 4, and/or to measurement points 3 of the first measuring modality. According to block 145b or 148b, the corresponding points 4a, 3a can then be retrieved from this approach.

Alternatively or in combination, according to block 145c, or 148c, ascertaining corresponding points 4a, 3a can in each case comprise interpolating the corresponding points 4a, 3a between points in the at least one image 4, or between measurement points 3 of the first measuring modality.

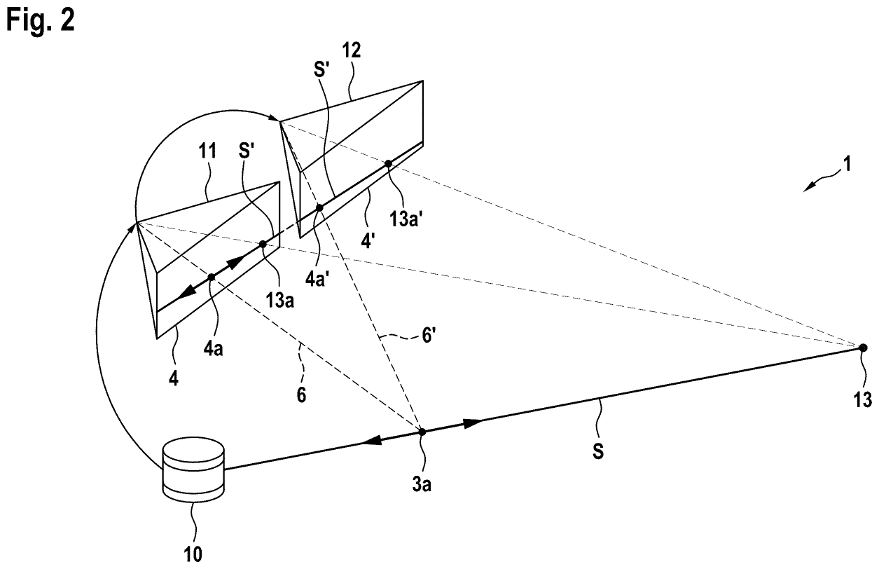

FIG. 2 illustrates how lidar measurement data 3 can be merged with images 4, 4′. A lidar sensor 10 transmits an electromagnetic wave to an object 13 (drawn by way of example) that is located in an area 1 and reflects the electromagnetic wave. This reflection is considered as the view beam S in a geometric approximation. The object 13 is furthermore observed by two stereoscopically arranged cameras 11 and 12, which provide images 4 and 4′, respectively. Due to the different perspectives from which the cameras 11 and 12 observe the object 13, the object 13 appears at different locations 13a and 13a′ in the images 4 and 4′.

From the geometric arrangement 5 of the lidar sensor 10 and of the two cameras 11 and 12 in relation to one another, correspondences 6, 6′ follow as to which points 4a, 4a′ in the image 4, or 4′, relate to the same location 1a in the area 1 as the point 3a on the view beam S. The position information of this location 1a that is provided by the point 3a is a hypothesis 7a-7c for the position of this location 1a, which hypothesis is to be merged with further hypotheses 7a-7c. Such further hypotheses 7a-7c may, for example, be obtained from the combination of the images 4 and 4′. The points 4a, 4a′ corresponding to point 3a are located on a projection S′ of the view beam S in the images 4 and 4′.

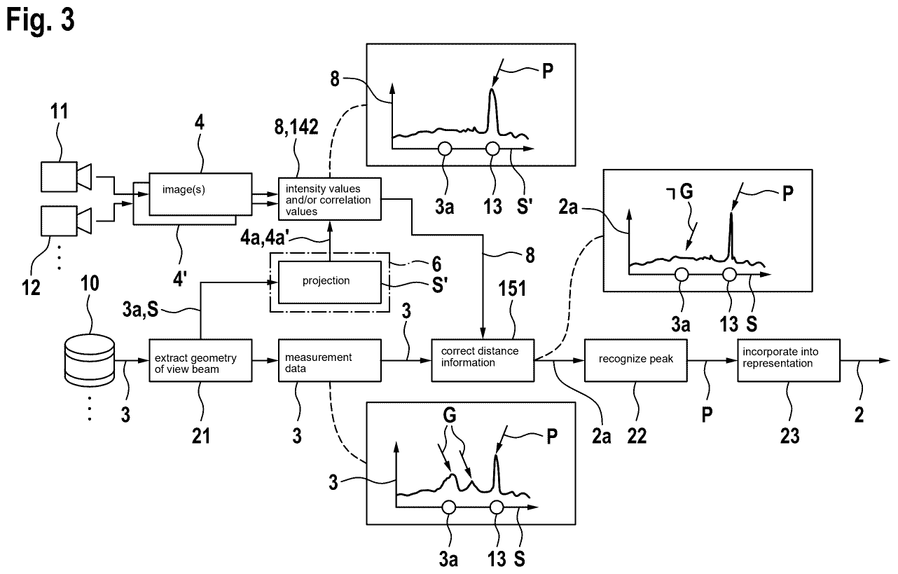

FIG. 3 illustrates how the distances ascertained in a lidar measurement can be corrected by additionally using the images 4, 4′ (“lidar-centric approach”). In block 21, the geometry of the view beam S, which geometry also defines the points 3a located on said view beam, is extracted from the lidar measurement data 3. The view beam S is projected into the images 4, 4′, and from the correspondence 6 follows which points 4a, 4a′ in the images 4, 4′ correspond to a given point 3a on the view beam S.

According to block 142, image portions (patches) around these points 4a, 4a′ are respectively extracted from the images 4, 4′, and correlations 8 between these patches are calculated. This correlation 8 is a numerical value assigned to the point 3a on the view beam S. According to block 151, it can be merged with the original lidar measurement data 3.

In the original lidar measurement data 3, in addition to a first peak P, which relates to the object 13 shown in FIG. 2, two further ghost peaks G, which do not relate to any real object, can also be seen. The correlation 8 does not have these ghost peaks G, but the peak P is extended to form the real object 13. The fusion of both items of information according to block 151 results in improved depth information 2a with respect to the locations la to which the points 3a on the view beam S relate. This improved depth information 2a is the form of an improved lidar spectrum in the example shown in FIG. 3. The ghost peaks G disappear. At the same time, the peak P, which relates to the real object 13, is significantly sharper. Thus, if this peak P is recognized according to block 22 and the distance, indicated thereby, of the object 13 to the lidar sensor 10 is incorporated according to block 23 into the ultimately desired representation 2 of the area 1, the accuracy and quality of this representation 2 as a whole is improved.

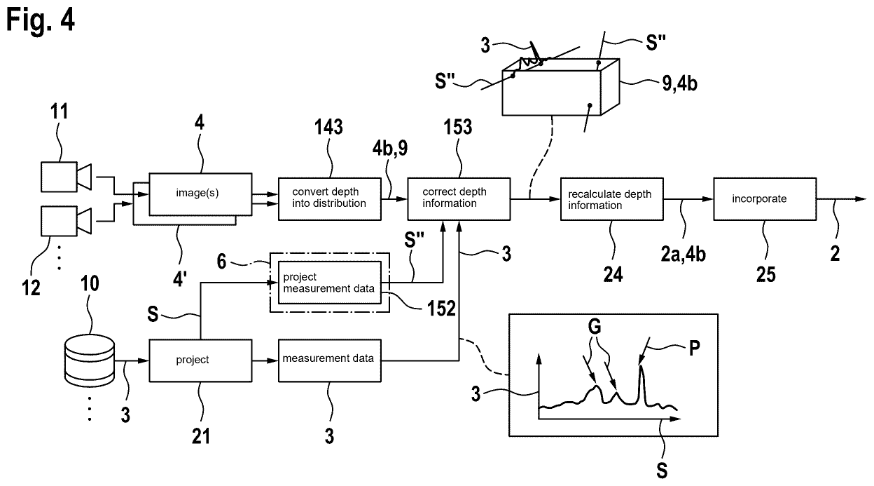

FIG. 4 illustrates how depth information 4b obtained from the images 4, 4′ due to the stereoscopic arrangement of the cameras 11 and 12 can be corrected by additionally using the lidar measurement data 3 (“camera-centric approach”). According to block 143, the depth information 4b is converted into a distribution 9 of intensity values in a correlation volume. The view beam S extracted analogously to FIG. 3 in block 21 from the lidar measurement data 3 is projected on the basis of the correspondence 6 into the correlation volume, where it takes the form S″. Along this projected view beam S″, the lidar measurement data 3 are plotted in the correlation volume so that they can be fused with the intensity values entered there. The lidar measurement data 3 may, for example, be introduced as an additional layer and also taken into account in the recalculation of the depth information 4b. However, the lidar measurement data 3 may also be used in a calculation with the image information in the correlation volume in any other manner, for example as weighting factors for image information.

Analogously to FIG. 3, the lidar measurement data 3 comprise the ghost peaks G, which do not relate to any real object, in addition to the peak P, which relates to the real object 13. Nevertheless, taking them into account in the recalculation of the depth information 4b in block 24 results in updated depth information 2a with a significantly improved accuracy. If this updated depth information 2a is incorporated into the representation 2 of the area 1 (block 25), the accuracy and quality of this representation 2 as a whole is improved.

1-16. (canceled)

17. A method for creating a representation, containing depth and/or distance information, of an area from measurement data obtained by observing the area, the method comprising the following steps:
providing measurement data of a first measuring modality, which transmits an electromagnetic or acoustic wave into the observed area and receives a reflected wave from this area, wherein the measurement data contain an interesting property of the reflected wave, which depends on a distance between a location of reflection and a sensor used for the measurement, along a view beam;
providing at least one image of the observed area that was acquired with a second measuring modality;
from a geometric arrangement of sensors used for the first and second measuring modalities, in relation to one another, ascertaining correspondences as to which points of the at least one image on the one hand and points along the view beam on the other hand relate to the same location in the area;
for the same location in the area, formulating multiple hypotheses relating to a position of the location in space are in each case formulated using the measurement data of the first measuring modality, and/or the at least one image, and/or the ascertained correspondences; and
aggregating the hypotheses in a desired representation to form depth and/or distance information with respect to the location.

18. The method according to claim 17, wherein the depth and/or distance information includes at least one coordinate of the position of the location in space, and/or a distance between the location and a specified reference point.

19. The method according to claim 17, wherein a radar measurement or a lidar measurement or an ultrasonic measurement is the first measuring modality.

20. The method according to claim 17, wherein at least one of the hypothesis is formulated:
using the measurement data of the first measuring modality on the one hand and information from the at least one image on the other hand, which relate to the same location as evidenced by the correspondences, and/or
using images acquired by two or more cameras of a stereoscopic camera arrangement and/or by at least one moving camera with a structure-from-motion technique, and/or
using the image in combination with additional depth information with respect to the image.

21. The method according to claim 20, wherein the at least one of the hypothesis is formulated using the image in combination with the addition depth information with respect to the image, wherein the additional depth information with respect to the image is ascertained with a trained artificial neural network.

22. The method according to claim 21, wherein:
a profile of intensity values and/or correlation values along the view beam is ascertained from the stereoscopically acquired images, or from the image and the additional depth information, in conjunction with a geometry of the view beam and the correspondences; and
distance information in the measurement data of the first measuring modality is corrected such that a profile of the measurement data along the view beam is as consistent as possible with the ascertained profile of the intensity values and/or correlation values.

23. The method according to claim 21, wherein
a distribution of intensity values in a correlation volume is ascertained from the stereoscopically acquired images, or from the image and the additional depth information;
the measurement data along the view beam are projected into the correlation volume; and
depth information obtained from the stereoscopically acquired images, or the additional depth information, is corrected such that a distribution of the intensity values in the correlation volume is as consistent as possible with the measurement data of the first measuring modality.

24. The method according to claim 17, wherein points along the view beam are sampled based on a geometric description of the view beam, and:
(i) based on the geometric arrangement of the sensors used for the first and second measuring modalities, in relation to one another, points corresponding to the sampled points are ascertained in the at least one image, and/or
(ii) multiple hypotheses relating to positions of the sampled points in space are in each case formulated and aggregated.

25. The method according to claim 17, wherein points are sampled from the at least one image, and:
(i) based on the geometric arrangement of the sensors used for the first and second measuring modalities, in relation to one another, points corresponding to the sampled points are ascertained along the view beam, and/or
(ii) multiple hypotheses relating to positions of the sampled points in space are in each case formulated and aggregated.

26. The method according to claim 24, wherein the ascertaining of the corresponding points in each case includes:
fitting a parametrized approach to the points in the at least one image, or to measurement points of the first measuring modality, and
retrieving the corresponding points from the fitting.

27. The method according to claim 24, wherein the ascertaining of the corresponding points in each case includes interpolating the corresponding points between points in the at least one image, or between measurement points of the first measuring modality.

28. The method according to claim 17, wherein the observed area is an environment of a vehicle or robot.

29. The method according to claim 28, wherein:
a control signal is ascertained from the representation, and
the vehicle or the robot is controlled with the control signal.

30. A non-transitory machine-readable data carrier on which is stored a computer program including machine-readable instructions for creating a representation, containing depth and/or distance information, of an area from measurement data obtained by observing the area, the instructions, when executed by one or more computers, causing the one or more computers to perform the following steps:
providing measurement data of a first measuring modality, which transmits an electromagnetic or acoustic wave into the observed area and receives a reflected wave from this area, wherein the measurement data contain an interesting property of the reflected wave, which depends on a distance between a location of reflection and a sensor used for the measurement, along a view beam;
providing at least one image of the observed area that was acquired with a second measuring modality;
from a geometric arrangement of sensors used for the first and second measuring modalities, in relation to one another, ascertaining correspondences as to which points of the at least one image on the one hand and points along the view beam on the other hand relate to the same location in the area;
for the same location in the area, formulating multiple hypotheses relating to a position of the location in space are in each case formulated using the measurement data of the first measuring modality, and/or the at least one image, and/or the ascertained correspondences; and
aggregating the hypotheses in a desired representation to form depth and/or distance information with respect to the location.

31. One or more computers configured to create a representation, containing depth and/or distance information, of an area from measurement data obtained by observing the area, the one or more computers configured to:
provide measurement data of a first measuring modality, which transmits an electromagnetic or acoustic wave into the observed area and receives a reflected wave from this area, wherein the measurement data contain an interesting property of the reflected wave, which depends on a distance between a location of reflection and a sensor used for the measurement, along a view beam;
provide at least one image of the observed area that was acquired with a second measuring modality;
from a geometric arrangement of sensors used for the first and second measuring modalities, in relation to one another, ascertain correspondences as to which points of the at least one image on the one hand and points along the view beam on the other hand relate to the same location in the area;
for the same location in the area, formulate multiple hypotheses relating to a position of the location in space are in each case formulated using the measurement data of the first measuring modality, and/or the at least one image, and/or the ascertained correspondences; and
aggregate the hypotheses in a desired representation to form depth and/or distance information with respect to the location.
